(19) United States
(12) Patent Application Publication
(10) Pub. No.: US 2006/0197061 A1
(43) Pub. Date: Sep. 7, 2006

(54) Green phosphor composition for plasma display panel and plasma display panel prepared from the same

(76) Inventor: Seung-Uk Kwon, Chunan-si (KR)

Correspondence Address: CHRISTIE, PARKER & HALE, LLP, PO BOX 7068, PASADENA, CA, 91109-7068, US

(21) Appl. No.: 11/367,187

(22) Filed: Mar. 3, 2006

(30) Foreign Application Priority Data
Mar. 4, 2005 (KR) 10-2005-0018167

(51) Int. Cl. C09K 11/08; C09K 11/77

(52) U.S. Cl. 252/301.4 F; 252/301.4 R; 428/404; 428/403; 313/582; 313/584

(57) ABSTRACT

The green phosphor composition for a plasma display panel includes a phosphor comprising at least one fluorescent material selected from the group consisting of Zn₂₋ₓMnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8≦y≦47), ReBO₃:Tb (Re is at least one rare earth element selected from the group consisting of Sc, Y, La, Ce, Gd and combinations thereof), MgAlₓO_{y}:Mn (1≦x≦10, 1≦y≦30), and combinations thereof, and an oxide of a rare earth element coated on the surface of the fluorescent material. Alternatively, the green phosphor includes a mixture of the fluorescent material and an oxide of a rare earth element.

### CROSS-REFERENCE TO RELATED APPLICATION

This application claims priority to and the benefit of Korean Patent Application No. 10-2005-0018167 filed in the Korean Intellectual Property Office on Mar. 4, 2005, the entire content of which is incorporated herein by reference.

### FIELD OF THE INVENTION

The present invention relates to a green phosphor composition for a plasma display panel and a plasma display panel prepared from the same. More particularly, the present invention relates to a green phosphor composition which can improve the charge amount of a phosphor and reduce the discharge variation due to black dots, and reduce the address driving voltage to ensure an address margin.

### BACKGROUND OF THE INVENTION

A plasma display panel (PDP) is a flat panel display device using a plasma phenomenon, which is also called a gas-discharge phenomenon since a discharge is generated in the panel when a potential greater than a certain level is applied to two electrodes separated from each other under a gas atmosphere in a non-vacuum state.

The gas-discharge phenomenon is applied to display an image in the plasma display panel. Currently, a plasma display panel is generally a reflective, alternating current driving plasma display panel in which phosphor layers are formed on the barrier ribs of a rear structure.

In order to obtain a plasma display panel with uniform and stable discharge, the phosphors should have a high surface potential so that gas anions may collide with the phosphor layers at high speed and at a high temperature. As the surface potential of the phosphors is high, the potential difference between phosphors and anions is large, so that the plasma discharge may realize uniform and stable photoluminescence characteristics.

Korean Patent Publication No. 2000-0050934 discloses an increase of the surface potential by mixing barium-based green phosphor powders having a positive surface potential to heighten the surface potential and provide a plasma display panel having uniform discharge characteristics, the entire contents thereof are incorporated herein by reference. Korean Patent Publication No. 1998-0024014 discloses inhibition of phosphor deterioration by using an acryl resin, the entire contents thereof are incorporated herein by reference. This inhibition, however, is not sufficient for controlling the surface potential. Korean Patent Publication No. 2001-0049127 discloses an improvement on photoluminescence characteristics of a plasma display panel by forming an electrostatically charged coating layer on a phosphor layer, the entire contents thereof are also incorporated herein by reference. However, with the improvement of this disclosure, an additional process should be carried out during panel fabrication.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An embodiment of the invention provides a green phosphor composition for a plasma display panel which can reduce discharge variation due to black dots, as well as reduce the address driving voltage to ensure obtaining an address margin, by coating an oxide of a rare earth element on a surface of a fluorescent material.

Another embodiment of the invention provides a plasma display panel which is prepared using the green phosphor composition above. The plasma display can have an improved display quality due to the improvements of the discharge variation and the surface charge-to-mass ratio, and can ensure a driving voltage margin.

According to one embodiment of the invention, a green phosphor composition for a plasma display panel is provided which includes a green phosphor comprising a fluorescent material selected from the group consisting of Zn₂₋ₓMnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8≦y≦47), ReBO₃:Tb (Re is at least one rare earth element selected from the group consisting of Sc, Y, La, Ce, Gd, and combinations thereof), MgAlₓO_{y}:Mn (1≦x≦10, 1≦y≦30), and combinations thereof, and an oxide of a rare earth element coated on the surface of the fluorescent material.

According to another embodiment of the invention, a green phosphor composition for a plasma display panel is provided which includes a mixture of a fluorescent material selected from the group consisting of Zn₂₋ₓMnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8≦y≦47), ReBO₃:Tb (Re is at least one rare earth element selected from the group consisting of Sc, Y, La, Ce, Gd, and combinations thereof), MgAlₓO_{y}:Mn (1≦x≦10, 1≦y≦30), and combinations thereof, and an oxide of a rare earth element.

According to a further embodiment of the invention, a plasma display panel is provided including a pair of substrates having a transparent front surface and disposed to leave a discharge space therebetween, a plurality of barrier ribs disposed on one substrate to partition the discharge space into a plurality of spaces, a group of electrodes disposed on the substrates to discharge in the discharge spaces partitioned by the barrier ribs, and red, green, and blue phosphor layers formed in the discharge spaces partitioned by the barrier ribs. The green phosphor layer is formed by coating a green phosphor composition including a green phosphor which comprises a fluorescent material selected from the group consisting of Zn₂₋ₓMnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8≦y≦47), ReBO₃:Tb (Re is at least one rare earth element selected from the group consisting of Sc, Y, La, Ce, Gd, and combinations thereof), MgAlₓO_{y}:Mn (1≦x≦10, 1≦y≦30), and combinations thereof, and an oxide of a rare earth element coated on the surface of the fluorescent material.

According to an additional embodiment of the invention, a plasma display panel is provided including a pair of substrates having a transparent front surface and disposed to leave a discharge space therebetween, a plurality of barrier ribs disposed on one substrate to partition the discharge space into a plurality of spaces, a group of electrodes disposed on the substrates to discharge in the discharge spaces partitioned by the barrier ribs, and red, green, and blue phosphor layers formed in the discharge spaces partitioned by the barrier ribs. The green phosphor layer is formed by coating a green phosphor composition including a mixture of a fluorescent material selected from the group consisting of Zn₂₋MnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8 ≦y≦47), ReBO₃:Tb (Re is at least one rare earth element selected from the group consisting of Sc, Y, La, Ce, Gd, and combinations thereof), MgAlₓO_{y}:Mn (1≦x≦10, 1≦y≦30), and combinations thereof, and an oxide of a rare earth element.

### BRIEF DESCRIPTION OF THE DRAWING

FIG. 1 is an exploded perspective view showing one embodiment of a plasma display panel of the invention.

### DETAILED DESCRIPTION OF THE INVENTION

Zn₂₋ₓMnₓSiO₄ (0.1≦x≦0.5), having a surface charge-to-mass ratio of −50 μC/g, is a common green phosphor for a plasma display panel. This value is much lower than those of a red phosphor (for example, (Y,Gd)BO₃:Eu³⁺ has a charge-to-mass ratio of 52 μC/g) and a blue phosphor (for example, BaMgAl₁₀O₁₇:Eu²⁺ has a charge-to-mass ratio of 41 μC/g). A Zn₂SiO₄:Mn green phosphor is prepared by mixing and firing solid raw materials comprising ZnO, SiO₂, and MnCO₃.

During the preparation process, an intermediate product having a non-uniform composition ratio is formed, to produce a phosphor having a negative surface potential. Upon the reset discharge while driving a plasma display, wall charges are built up. As the wall charges of the cations are counterbalanced by the green phosphor which has a negative surface potential, the green phosphor may resultantly require an increase of address discharge voltage for the next address discharge duration. The green phosphor, with lower surface potential, may require a higher address discharge voltage compared to the red and blue phosphors. Accordingly, research has been undertaken in order to heighten the surface potential of green phosphors to a degree similar to those of red and blue phosphors.

The green phosphor composition of the invention comprises a green fluorescent material coated with an oxide of a rare earth metal, and a mixture of a green fluorescent material and an oxide of a rare earth metal. Thereby, the charge-to-mass ratio of the green phosphor and the discharge variation due to a black dot of a panel can be improved, as can the address driving voltage be improved to ensure an address margin.

According to one embodiment of the invention, the green phosphor composition for a plasma display panel includes a green phosphor comprising a fluorescent material and an oxide of a rare earth element coated on the fluorescent material.

Non-limiting examples of the fluorescent material include any fluorescent material having a negative surface potential, or a relatively lower potential, such as Zn₂₋ₓMnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8≦y≦47), ReBO₃:Tb (Re is at least one rare earth element selected from the group consisting of Sc, Y, La, Ce, Gd, and combinations thereof), MgAlₓO_{y}:Mn (1≦x≦10, 1≦y≦30) and combinations thereof.

In an embodiment, non-limiting examples of the oxides of rare earth elements include one selected from the group consisting of yttrium, scandium, cerium, gadolinium, and combinations thereof, and preferably one selected from Y₂0₃, Sc₂O₃, Ce₂O₄, Gd₂O₃, and combinations thereof.

In another embodiment, the green phosphor composition includes a green phosphor comprising a fluorescent material of Zn₂₋ₓMnₓSiO₄ (0.07≦x≦0.2) and Y₂O₃ coated on the fluorescent material, and preferably, a green phosphor comprising a fluorescent material of Zn₂₋ₓMnₓSiO₄ (0.09≦x≦0.11) and Y₂O₃ coated on the fluorescent material.

The greater the amount of the coating of the oxide of rare earth elements, the more improved the charge-to-mass ratio of the phosphor is. However, there is no need for an improvement over a predetermined level of the charge-to-mass ratio in a plasma display panel, and when the coating layer of the oxide of the rare earth elements is too thick, the oxide of the rare earth elements has excessive absorption properties for the long wavelength of 172 nm vacuum ultraviolet rays (VUV). Therefore, the coating needs to be controlled appropriately. Since recent plasma display panels use a discharge gas including a high content of xenon (Xe), a large amount of absorption of 172 nm VUV may deteriorate brightness characteristics of the plasma display panel. In one embodiment, the appropriate amount of coating is regulated by controlling the coating thickness.

In one embodiment, the rare earth element oxide coating layer has an average thickness ranging from 5 to 20 nm, preferably from 5 to 18 nm, and more preferably from 5 to 15 nm. When the coating layer thickness is less than 5 nm, improvement of the charge-to-mass ratio is negligible, resulting in lack of improvement of discharge variation. When it is more than 20 nm, brightness may be reduced.

In an embodiment, the rare earth element oxide is coated in the amount of 1 to 5 wt %, preferably 1.3 to 4.7 wt %, of the total weight of the green phosphor. When the amount of rare earth element oxide coated is less than 1 wt %, an improvement of the charge-to-mass ratio is negligible, resulting in lack of improvement of the discharge variation. When it is more than 5 wt %, the surface potential may be improved, but absorption of vacuum ultraviolet rays is too excessive, resulting in reduction of the brightness and brightness maintenance ratio (life-span characteristics).

The rare earth element oxide coating layer may be formed on a partial or entire surface of the fluorescent material.

In one embodiment, the coating may generally be performed using dry or wet coating methods where the wet coating method includes a doctor blade method, a dipping method, a reverse roll method, a direct roll method, a gravure method, an extrusion method, a brush method, and the like, and the dry coating method includes plasma chemical vapor deposition (PVD), chemical vapor deposition (CVD), sputtering, electron beam evaporation, vacuum thermal evaporation, laser ablation, thermal evaporation, laser chemical vapor deposition, zet vapor deposition, and the like, but is not limited thereto.

In one embodiment, the green phosphor composition may include the green phosphor in the amount of 28 to 44 wt %, and more preferably 32 to 40 wt % of the total amount of the phosphor composition. When the amount of the green phosphor is within the above range, the phosphor layer in a discharge cell may be formed with an appropriate thickness resulting in optimal brightness and discharge characteristics. When it is less than 28 wt %, the phosphor layer is very thin and brightness is reduced. When it is more than 44 wt %, the phosphor layer is too thick and thus life-span is reduced and discharge characteristics are deteriorated.

In another embodiment, the green phosphor composition may also include a fluorescent material selected from the group consisting of Zn₂₋ₓMnₓSiO₄ (0.07≦x≦0.2), (Zn,A)₂SiO₄:Mn (A is an alkaline earth metal), (BaSrMg)O.aAl₂O₃:Mn (1≦a≦23), (LaMgAlₓO_{y}:Tb) (1≦x≦14, 8≦y≦47), ReBO₃:Tb (Re is at least one rare earth element selected from the group consisting of Sc, Y, La, Ce, Gd, and combinations thereof), MgAlₓO_{y}:Mn (1≦x≦10, 1≦y≦30), and combinations thereof, as well as the green phosphor.

In a further embodiment, the fluorescent material may be present in the amount of 20 to 100 parts by weight, and preferably 40 to 80 parts by weight on 100 parts by weight of the green phosphor composition. On the other hand, if the surface coated phosphor less than 20 parts by weight, there is little improvement in surface potential, and it is also not preferable because characteristics of an uncoated phosphor are more intensively realized than those of a coated phosphor. In one embodiment when color or other characteristics are intended by use of an uncoated phosphor, the coated phosphor is included in the amount of 80 parts by weight based on 100 parts by weight of the green phosphor composition, thereby obtaining an optimal effect.

According to another embodiment, a green phosphor composition includes a mixture of fluorescent material and an oxide of a rare earth element.

In one embodiment, the green phosphor composition may include a mixture comprising a fluorescent material of Zn₂₋ₓMnₓSiO₄ (0.07≦x≦0.2) and the rare earth element oxide Y₂O₃, and preferably a fluorescent material of Zn₂₋ₓMnₓSiO₄ (0.09≦x≦0.11) and the rare earth element oxide Y₂O₃.

The fluorescent material and the rare earth element oxides are those listed in the embodiments above. In one embodiment, the fluorescent material and the rare earth element oxide may be mixed in a weight ratio ranging from 1:99 to 10:90, and preferably ranging from 3:97 to 7:93. When the fluorescent material is mixed with a rare earth element oxide, a relatively greater amount of the rare earth element oxide is needed in order to obtain the same improvement in discharge variation as is achieved in coating the rare earth element oxide on the surface of the fluorescent material. When the mixing ratio of the fluorescent material and the rare earth element oxide is within the above ranges, its surface potential is sufficiently improved, whereas, when it is out of the range, the surface potential is not improved. When the rare earth element oxide is present in an excessive amount, there are problems of discharge and life-span, and brightness may be reduced.

The green phosphor composition according to the embodiments above may include a binder resin and a solvent.

In one embodiment, the binder resin includes cellulose resins, acrylic resins, and mixtures thereof. Examples of cellulose resins include methyl cellulose, ethyl cellulose, propyl cellulose, hydroxy methyl cellulose, hydroxy ethyl cellulose, hydroxy propyl cellulose, hydroxy ethyl propyl cellulose, and mixtures thereof. Examples of acrylic resins include poly methyl methacrylate, poly isopropyl methacrylate, poly isobutyl methacrylate, or methyl meta acrylate, ethyl meta acrylate, propyl meta acrylate, butyl meta acrylate, hexyl meta acrylate, 2-ethyl hexyl meta acrylate, benzyl meta acrylate, dimethyl amino ethyl meta acrylate, hydroxy ethyl meta acrylate, hydroxy propyl meta acrylate, hydroxy butyl meta acrylate, phenoxy 2-hydroxy propyl meta acrylate, glycidyl meta acrylate, methyl acrylate, ethyl acrylate, propyl acrylate, butyl acrylate, hexyl acrylate, 2-ethyl hexyl acrylate, benzyl acrylate, dimethyl amino ethyl acrylate, hydroxy ethyl acrylate, hydroxy propyl acrylate, hydroxy butyl acrylate, phenoxy 2-hydroxy propyl acrylate, glycidyl acrylate, and mixtures thereof. The phosphor composition according to an embodiment of the invention may further include a small amount of inorganic binder.

In one embodiment, the amount of the binder may be in the range of about 2 to 8 wt % based on the total weight of the phosphor composition.

In a further embodiment, examples of the solvent for the phosphor composition include alcohols, ethers, esters, and mixtures thereof with preferred examples including butyl cellosolve (BC), butyl carbitol acetate (BCA), terpineol, and mixtures thereof. If the amount of the solvent is too large or too small, the fluidity of the phosphor composition is not suitable for coating. In one embodiment, the amount of the solvent may be in the range of about 25 to 75 wt %.

In another embodiment, the phosphor composition according to the invention may further include an additive for improved fluidity and processing properties like, a photosensitizer such as benzophenone, a dispersing agent, a silicon-based antifoaming agent, a rheology modifier, a plasticizer, an antioxidant, and the like, which may be used individually or in combination. Commercially available additives well known to those skilled in the art may be used for these purposes.

According to one embodiment of the invention, a plasma display panel includes a pair of substrates having a transparent front surface and being disposed to leave a discharge space therebetween, a plurality of barrier ribs disposed on one substrate to partition the discharge space into many spaces for the discharge, a group of electrodes disposed on the substrates to discharge in the discharge spaces partitioned by the barrier ribs, and red, green, and blue phosphor layers formed in the discharge spaces partitioned by the barrier ribs. The green phosphor layer is formed by coating a green phosphor composition in accordance with the embodiments above.

According to another embodiment of the invention, a plasma display panel includes a green phosphor layer which is formed by coating a green phosphor composition in accordance with the second embodiment in a discharge cell.

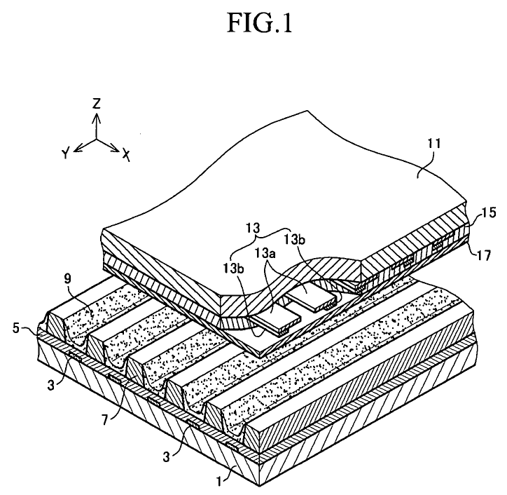

FIG. 1 is an exploded perspective view showing one embodiment of a plasma display panel of the invention, and the plasma display panel of the invention is not limited to the structure illustrated in FIG. 1. Referring to the drawing, in the plasma display panel, address electrodes 3 are arranged along the one direction (Y direction in the drawing) on a first substrate 1, and a dielectric layer 5 is formed covering the address electrodes 3 on the entire surface of the first substrate 1. Barrier ribs 7 are formed on the dielectric layer 5, and red (R), green (G), and blue (B) phosphor layers 9 are positioned between the barrier ribs 7. The green phosphor layers 9 include the green phosphor compositions of either of the embodiments above.

In one embodiment, display electrodes 13 include scan electrodes and sustain electrodes. Each scan electrode comprises a transparent electrode 13a and a bus electrode 13b. Each sustain electrode also comprises a transparent electrode 13 and a bus electrode 13b. The display electrodes 13 are formed along a direction (X direction in the drawing) crossing the address electrodes 3 on one surface of a second substrate 11 facing the first substrate 1, and a transparent dielectric layer 15 and a protection layer 17 covering the display electrodes 13 are positioned on the entire surface of the second substrate 11. A discharge cell is formed at crossing position of the address electrodes 3 and the display electrodes 13

When a certain level of address voltage (Va) is applied between an address electrode 3 and a display electrode 13, and a discharge sustain voltage (Vs) is applied between a pair of electrodes of the display electrode 13 (the scan electrode and sustain electrode), vacuum ultraviolet rays generated during sustain discharge excite the corresponding phosphor layer 9 to emit visible rays through the substrate 11.

The plasma display panel of the invention includes a green phosphor layer formed in a discharge cell using a green phosphor composition.

Any methods of manufacturing a phosphor layer and other elements of a plasma display panel and any structure thereof that are widely known may be applied to a plasma display panel according to the invention. Therefore, detailed descriptions of a method of manufacturing a plasma display panel according to the invention and its structure are not provided.

In an embodiment, the green phosphor layer can be prepared as follows. First, the coated green phosphor, or a mixture of fluorescent material and a rare earth element oxide, is dispersed in a vehicle, which is prepared by dissolving a binder resin in a solvent to prepare a phosphor composition which is a paste.

The obtained phosphor paste is coated on the surface of a discharge cell to provide a phosphor layer. The phosphor is coated on a surface of the dielectric layer 15 on the surface of the second substrate 11 and side walls of the barrier rib 7. In one embodiment, the coating method of the phosphor composition may include, but is not limited to, screen printing or spraying the phosphor composition from a nozzle. The coated layer is then fired at a temperature sufficient to decompose or burn the binder resin, to provide a phosphor layer.

The green phosphor composition can provide a plasma display having improved display quality due to improvement of the discharge variation due to black dots and the surface charge-to-mass ratio, and can ensure a driving voltage margin.

The following examples illustrate the invention in further detail; however, it is understood that the invention is not limited by these examples.

### EXAMPLES 1 TO 6 AND COMPARATIVE EXAMPLE 1

Green phosphors were prepared by coating Y₂O₃ on the surface of Zn_{1.89}Mn_{0.11}SiO₄ by deposition using a target including Y₂O₃ under a pressure of 5 mTorr, an RF power of 300 W, and an argon atmosphere. Coating amounts of Y₂O₃ and thickness of the coating layer were as shown in Table 1.

TABLE 1

| | Green phosphor | Y₂O₃ coating | Y₂O₃ coating |
|---|---|---|---|
| | (mg) | amount (wt %) | thickness (nm) |
| Comp. | Zn_{1.89}Mn_{0.11}SiO₄ | — | — |
| Example 1 | | | |
| Example 1 | Zn_{1.89}Mn_{0.11}SiO₄ | 0.85 | 0-3 |
| Example 2 | Zn_{1.89}Mn_{0.11}SiO₄ | 1.4 | 3-5 |
| Example 3 | Zn_{1.89}Mn_{0.11}SiO₄ | 2.7 | 5-10 |
| Example 4 | Zn_{1.89}Mn_{0.11}SiO₄ | 4.2 | 10-15 |
| Example 5 | Zn_{1.89}Mn_{0.11}SiO₄ | 5.5 | 15-20 |
| Example 6 | Zn_{1.89}Mn_{0.11}SiO₄ | 8.1 | 20-30 |

The green phosphors of Examples 1 to 6 and Comparative Example 1 were dispersed in a vehicle in which ethyl cellulose was dissolved in butyl carbitol acetate to obtain a phosphor paste. The phosphor paste was screen-printed between barrier ribs shown in FIG. 1 and fired at 500° C. to provide PDPs having the phosphor layer.

After only the green phosphor pattern of each of the PDPs was excited, the color coordinates, according to the CIE colorimetric system, of green light emitted from the PDPs, the brightness of the green light, and brightness maintenance ratio (life-span) with respect to ions were measured using a contact brightness meter (CA-100+). The surface electric charge (charge-to-mass ratio) of the phosphor powder was measured using a TB-200 instrument (an instrument for measuring the charge-to-mass ratio of powders, manufactured by Toshiba Chemical Co.), and zeta potential was measured using a Zeta Master instrument (manufactured by Malvern Company). The measurement results are shown in Table 2.

In Table 2, relative brightness is calculated as a percentage value based on the brightness of the phosphor according to Comparative Example 1. The brightness maintenance ratio was measured after ion sputtering as follows: The phosphors were positioned in a chamber filled with Xe gas and 5 W of electric power was applied for 30 minutes by using an electrode at each end of the chamber. Then, phosphor photoluminescence brightness was measured using a Kr lamp. The phosphor photoluminescence brightness of phosphors that underwent surface deterioration through ion sputtering is calculated as a percentage value based on initial brightness measured using a Kr Lamp to obtain a brightness maintenance ratio.

TABLE 2

| | | | | | | | | Brightness |
|---|---|---|---|---|---|---|---|---|
| | | | | | | | | maintenance |
| | | | | | | Surface | | ratio |
| | Coating | Coating | Color | Color | Relative | charge-to- | Zeta | after ion |
| | amount | thickness | coordinates | coordinates | brightness | mass ratio | potential | sputtering |
| | (wt %) | (nm) | (x) | (y) | (%) | (μC/g) | [mV] | (%) |
| Comp. | — | — | 0.237 | 0.702 | 100 | −50 | −42 | 88 |
| Ex. 1 | | | | | | | | |
| Ex. 1 | 0.85 | 0 to 3 | 0.237 | 0.702 | 100 | +15 | +14 | 89 |
| Ex. 2 | 1.4 | 3 to 5 | 0.237 | 0.702 | 100 | +43 | +35 | 90 |
| Ex. 3 | 2.7 | 5 to 10 | 0.237 | 0.702 | 99.9 | +54 | +38 | 89 |
| Ex. 4 | 4.2 | 10 to 15 | 0.237 | 0.702 | 99.3 | +62 | +41 | 87 |
| Ex. 5 | 5.5 | 15 to 20 | 0.237 | 0.702 | 98.4 | +70 | +46 | 88 |
| Ex. 6 | 8.1 | 20 to 30 | 0.237 | 0.702 | 97.1 | +73 | +48 | 89 |

As shown in Table 2, a rare earth element oxide coating does not cause reduction of the brightness maintenance ratio (life-span) by ion sputtering or a change of color coordinates of the phosphors. Since phosphors for a plasma display panel are photoluminescent (PL) materials excited by light, the coating may cause the reduction of brightness, but it was negligible and within an acceptable error range except for Examples 5 and 6. Therefore, the coating did not have a significant effect on brightness. As the coating amount of Y₂O₃ increases, and the charge-to-mass ratio reaches a predetermined level, the charge-to-mass ratio is increased negligibly, and brightness is decreased significantly. Therefore, the coating amount or the thickness of the coating layer should be optimized.

From the high surface charge-to-mass ratio and zeta potential of the phosphors according to Examples 1 to 6, the plasma display panel including the phosphors should have discharge stability.

In order to evaluate the discharge stability, after only the green phosphor pattern of each of the PDPs of Examples 1 to 6 was excited, the color coordinates of green light emitted from the PDPs, according to the CIE colorimetric system, and the relative brightness, discharge variation, minimum address voltage, and brightness maintenance ratio (life-span) were measured using a contact brightness meter (CA-100+, Toshiba Chemical Co.). The results are shown in Table 3.

In Table 3, relative brightness is a relative value based on 100 percent of Comparative Example 1. The brightness maintenance ratio of the plasma display panel is measured in a discharge tube including 5% Xe gas under a 500 torr atmosphere after 500 hours.

The discharge variation is calculated according to the following equation.

$$Nt / No = exp ( \frac{- ( t - tf )}{ts} )$$

where Nt denotes the number of times in which discharge fails to occur (i.e., discharge error) during the period of time t; No denotes the number of times the discharge delay was counted; tf denotes the delay in formation; and ts denotes the discharge variation.

The address voltage is the minimum voltage at address discharge.

TABLE 3

| | | | | | | Brightness |
|---|---|---|---|---|---|---|
| | Color | Color | Relative | | Minimum | maintenance |
| | coordinates | coordinates | brightness | Discharge | address voltage | ratio |
| | (x) | (y) | (%) | variation | (V) | (%) |
| Comp. | 0.239 | 0.699 | 100 | 592 | 61 | 82 |
| Example 1 | | | | | | |
| Example 1 | 0.239 | 0.699 | 100 | 353 | 57 | 82 |
| Example 2 | 0.239 | 0.699 | 99.8 | 78 | 43 | 81 |
| Example 3 | 0.239 | 0.699 | 99.6 | 56 | 42 | 81 |
| Example 4 | 0.239 | 0.699 | 98.9 | 50 | 40 | 82 |
| Example 5 | 0.239 | 0.699 | 95.9 | 52 | 40 | 82 |
| Example 6 | 0.239 | 0.699 | 93.2 | 48 | 40 | 83 |

As shown in Table 3, a coating thickness over 15 nm according to Examples 5 and 6 significantly decreases the brightness of the plasma display panel. The brightness decrease results from the absorption of 172 nm vacuum ultraviolet rays by Y₂O₃. Therefore, a coating thickness of over 20 nm causes a brightness decrease rather than an improvement of the charge-to-mass ratio. Further, in the case where the coating thickness is under 5 nm, improvement of the charge-to-mass ratio is negligible, resulting in little improvement of the discharge variation. Therefore, in one embodiment, the optimal coating thickness of a rare earth element oxide is found to be within the range of 5 to 20 nm.

The plasma display panels including phosphors according to Examples 2 to 4 can maintain an excellent brightness maintenance ratio (life-span characteristic) as well as reduce the discharge variation to less than ⅛ of that of Comparative Example 1. Additionally, they show a reduced minimum address voltage, which indicates improved discharge stability.

In one embodiment, the green phosphor includes a fluorescent material coated with a rare earth element oxide on its surface. The phosphor has an improved charge-to-mass ratio, and it can reduce the discharge variation due to block dots in the panel, and reduce the address driving voltage to ensure an address driving voltage margin.

While this invention has been described in connection with what is considered to be exemplary embodiments, it is to be understood that the invention is not limited to the disclosed embodiments, but, on the contrary, is intended to cover various modifications and equivalent arrangements included within the spirit and scope of the appended claims.

What is claimed is:

1. A phosphor composition for a plasma display panel, comprising:
a green phosphor comprising a fluorescent material selected from the group consisting of Zn₂₋ₓMnₓSiO₄ where 0.07≦x≦0.2, (Zn,A)₂SiO₄:Mn where A is an alkaline earth metal, (BaSrMg)O.aAl₂O₃:Mn where 1≦a≦23, (LaMgAlₓO_{y}:Tb) where 1≦x≦14 and 8≦y≦47, ReBO₃:Tb where Re is at least one rare earth element selected from the group consisting of Sc, Y, La, Ce, Gd, and combinations thereof, MgAlₓO_{y}:Mn where 1≦x≦10 and 1≦y≦30; and combinations thereof; and
an oxide of a rare earth element coated on the surface of the fluorescent material.

2. The phosphor composition of claim 1, wherein the oxide of a rare earth element comprises a rare earth element selected from the group consisting of yttrium, scandium, cerium, gadolinium, and combinations thereof.

3. The phosphor composition of claim 1, wherein the green phosphor comprises a fluorescent material of Zn₂₋ₓMnₓSiO₄ where 0.07≦x≦0.2, and Y₂O₃.

4. The phosphor composition of claim 1, wherein the oxide of a rare earth element is coated on a surface of the fluorescent material in a thickness ranging from 5 to 20 nm.

5. The phosphor composition of claim 1, wherein the rare earth element oxide is coated on a surface of the fluorescent material in the amount of 1 to 5 wt % based on the total weight of the green phosphor.

6. The phosphor composition of claim 1, wherein the green phosphor is present in the amount of 28 to 44 wt % based on the total weight of the phosphor composition.

7. The phosphor composition of claim 1, comprising the fluorescent material in the amount of 20 to 100 parts by weight based on 100 parts by weight of the phosphor composition.

8. The phosphor composition of claim 1, further comprising a uncoated fluorescent material selected from the group consisting of Zn₂₋ₓMnₓSiO₄ where 0.07≦x≦0.2, (Zn,A)₂SiO₄:Mn where A is an alkaline earth metal, (BaSrMg)O.aAl₂O₃:Mn where 1 ≦a≦23, (LaMgAlₓO_{y}:Tb) where 1≦x≦14 and 8≦y≦47, ReBO₃:Tb where Re is at least one rare earth element selected from the group consisting of Sc, Y, La, Ce, Gd, and combinations thereof, MgAlₓO_{y}:Mn where 1≦x≦10 and 1≦y≦30; and combinations thereof.

9. A phosphor composition for a plasma display panel, comprising:
a mixture of one fluorescent material selected from the group consisting of Zn₂₋ₓMnₓSiO₄ where 0.07≦x≦0.2, (Zn,A)₂SiO₄:Mn where A is an alkaline earth metal, (BaSrMg)O.aAl₂O₃:Mn where 1≦a≦23, (LaMgAlₓO_{y}:Tb) where 1≦x23 14 and 8≦y≦47, ReBO₃:Tb where Re is at least one rare earth element selected from the group consisting of Sc, Y, La, Ce, Gd, and combinations thereof, MgAlₓO_{y}:Mn where 1≦x≦10 and 1≦y≦30, and combinations thereof, and an oxide of a rare earth element.

10. The phosphor composition of claim 9, wherein the oxide of a rare earth element comprises a rare earth element selected from the group consisting of yttrium, scandium, cerium, gadolinium, and combinations thereof.

11. The phosphor composition of claim 9, wherein the green phosphor comprises a mixture of a fluorescent material of Zn₂₋ₓMnₓSiO₄ where 0.07≦x≦0.2 and an oxide of a rare earth element.

12. The phosphor composition of claim 9, wherein the fluorescent material and oxide of a rare earth element are mixed in a weight ratio of 1:99 to 10:90.

13. A plasma display panel comprising:
a pair of substrates having a transparent front surface and disposed to leave a discharge space therebetween;
a plurality of barrier ribs disposed on one substrate to partition the discharge space into a plurality of spaces;
a group of electrodes disposed on the substrates to discharge in the discharge spaces partitioned by the barrier ribs; and
red, green, and blue phosphor layers formed in the discharge spaces partitioned by the barrier ribs,
the green phosphor layer being formed by coating on a green phosphor composition comprising
a green phosphor comprising
a fluorescent material selected from the group consisting of Zn₂₋ₓMnₓSiO₄ where 0.07≦x≦0.2, (Zn,A)₂SiO₄:Mn where A is an alkaline earth metal, (BaSrMg)O.aAl₂O₃:Mn where 1≦a≦23, (LaMgAlₓO_{y}:Tb) where 1≦x≦14 and 8≦y≦47, ReBO₃:Tb where Re is at least one rare earth element selected from the group consisting of Sc, Y, La, Ce, Gd, and combinations thereof, MgAlₓO_{y}:Mn where 1≦x≦10 and 1≦y≦30, and combinations thereof, and an oxide of a rare earth element coated on the surface of the fluorescent material.

14. The plasma display panel of claim 13, wherein the oxide of a rare earth element comprises a rare earth element selected from the group consisting of yttrium, scandium, cerium, gadolinium, and combinations thereof.

15. The plasma display panel of claim 13, wherein the green phosphor comprises a fluorescent material of Zn₂₋ₓMnₓSiO₄ where 0.07≦x≦0.2, and Y₂O₃.

16. The plasma display panel of claim 13, wherein the oxide of a rare earth element is coated on a surface of the fluorescent material in a thickness ranging from 5 to 20 nm.

17. The plasma display panel of claim 13, wherein the oxide of a rare earth element is coated in an amount of 1 to 5 wt % based on the total weight of the green phosphor.

18. The plasma display panel of claim 13, wherein the green phosphor is present in the amount of 28 to 44 wt % based on the total weight of the phosphor composition.

19. The plasma display panel of claim 13, wherein the green phosphor comprises the fluorescent material in an amount of 20 to 100 parts by weight based on 100 parts by weight of the phosphor composition.

20. The plasma display panel of claim 13, further comprising a uncoated fluorescent material selected from the group consisting of Zn₂₋ₓMnₓSiO₄ where 0.07≦x≦0.2, (Zn,A)₂SiO₄:Mn where A is an alkaline earth metal, (BaSrMg)O.aAl₂O₃:Mn where 1 ≦a≦23, (LaMgAlₓO_{y}:Tb) where 1≦x≦14 and 8≦y≦47, ReBO₃:Tb where Re is at least one rare earth element selected from the group consisting of Sc, Y, La, Ce, Gd, and combinations thereof, MgAlₓO_{y}:Mn where 1≦x≦10 and 1≦y≦30; and combinations thereof.

21. A plasma display panel comprising:
a pair of substrates having a transparent front surface and disposed to leave a discharge space therebetween;
a plurality of barrier ribs disposed on one substrate to partition the discharge space into a plurality of spaces;
a group of electrodes disposed on the substrates to discharge in the discharge spaces partitioned by the barrier ribs; and
red, green, and blue phosphor layers formed in the discharge spaces partitioned by the barrier ribs,
the green phosphor layer being formed by coating a green phosphor composition comprising
a green phosphor comprising
a mixture of a fluorescent material selected from the group consisting of Zn₂₋ₓMnₓSiO₄ where 0.07≦x≦0.2, (Zn,A)₂SiO₄:Mn where A is an alkaline earth metal, (BaSrMg)O.aAl₂O₃:Mn where 1≦a≦23, (LaMgAlₓO_{y}:Tb) where 1≦x≦14 and 8≦y≦47, ReBO₃:Tb where Re is at least one rare earth element selected from the group consisting of Sc, Y, La, Ce, Gd,and combinations thereof, MgAlₓO_{y}:Mn where 1≦x≦10 and 1≦y≦30, and combinations thereof, and an oxide of a rare earth element.

22. The plasma display panel of claim 21, wherein the oxide of a rare earth element comprises a rare earth element selected from the group consisting of yttrium, scandium, cerium, gadolinium, and combinations thereof.

23. The plasma display panel of claim 21, wherein the green phosphor comprises a fluorescent material of Zn₂₋ₓMnₓSiO₄ where 0.07≦x≦0.2, and Y₂O₃.

24. The plasma display panel of claim 21, wherein the fluorescent material and oxide of a rare earth element are mixed in a weight ratio of 1:99 to 10:90.
